(19) United States
(12) Patent Application Publication
(10) Pub. No.: US 2007/0290480 A1
(43) Pub. Date: Dec. 20, 2007

(54) VISE ATTACHMENT FOR TRAILER HITCH

(76) Inventor: Charles Wolter, St. Louis, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/752,009

(22) Filed: May 22, 2007

Related U.S. Application Data
(60) Provisional application No. 60/802,918, filed on May 24, 2006.

(51) Int. Cl. B62D 53/06

(52) U.S. Cl. 280/415.1

(57) ABSTRACT

An attachment (10) is provided for use with a trailer hitch (H). The attachment comprises a sleeve (12) inserted in the hitch and secured to the hitch. On the outer end of the sleeve is plate (18) to which is affixed a vise (22). The vise is used to clamp objects in place so they can be worked upon. The plate, which can be round, oval, square, rectangular, provides a work surface to assist the person using the attachment work on the clamped object.

### CROSS-REFERENCE TO RELATED APPLICATIONS

Provisional patent application 60/802,918 filed May 24, 2006

### STATEMENT REGARDING FEDERALLY SPONSORED RESEARCH

Not Applicable.

### BACKGROUND OF THE INVENTION

This invention relates to remote site operations carried out by any of a variety of contractors and work crews or the like, and more particularly to an attachment for the trailer hitch commonly found on pickup trucks and similar vehicles. The attachment includes a vise for clamping work pieces in place so they can be cut, welded, drilled, or otherwise operated on.

It is common at remote sites where activities may be on-going for some period of time for workbenches to be set up that allow for different operations required to be performed to be carried out. There are numerous types of such operations (cutting, sawing, welding, nailing, gluing, etc.) and they are carried out on a variety of materials (wood, metal, plastic). If it is known ahead of time that certain pieces are going to be required, these can be prepared off-site at an installation designed for specific operations and supplied in a timely manner to the work site. It often happens, however, that something unforeseen occurs (the piece doesn't quite fit, something breaks and needs to be replaced, etc.) and the contractor or work crew must be ready to deal with these situations so as not to lose valuable time.

One tool that is often required for field operations is a vise. While vises are relatively small and so are easily carried in a tool box, to be effectively used, they must first be clamped to some object that a) prevents the clamp from moving, b) allows the work piece to be readily clamped in place, and c) allows the worker ready access to the piece to perform whatever operations are required. If a workbench, 2×4s, or similar wood or metal pieces are available, this is easily accomplished. But this is not always the case. The present invention solves this problem.

### BRIEF SUMMARY OF THE INVENTION

In accordance with the present invention, an attachment is provided for use with the trailer hitch commonly found on the back of a pickup and other trucks for connecting a trailer to it. The attachment comprises a sleeve sized to be inserted into an opening in the hitch and secured to the hitch. On the outer end of the sleeve is a horizontal plate to which is affixed a vise. The vise is used to clamp objects in place so they can be worked upon. The plate, which can be round, oval, square, rectangular, or another convenient shape, provides a work surface to assist the person using the attachment to work on the clamped object. The attachment extends only a short distance outwardly from the hitch and its overall length is such it can be conveniently stored in a truck bed, toolbox, or behind or under a seat in the vehicle.

Other object and features will be in part apparent and in part pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a representation of a truck with a trailer hitch;

FIG. 2 is a perspective view of the vise attachment of the present invention installed on the hitch;

FIG. 3 is an end view of the attachment inserted in the hitch;

FIG. 4 is a side view thereof; and,

FIG. 5 is a side view of an alternate trailer hitch construction.

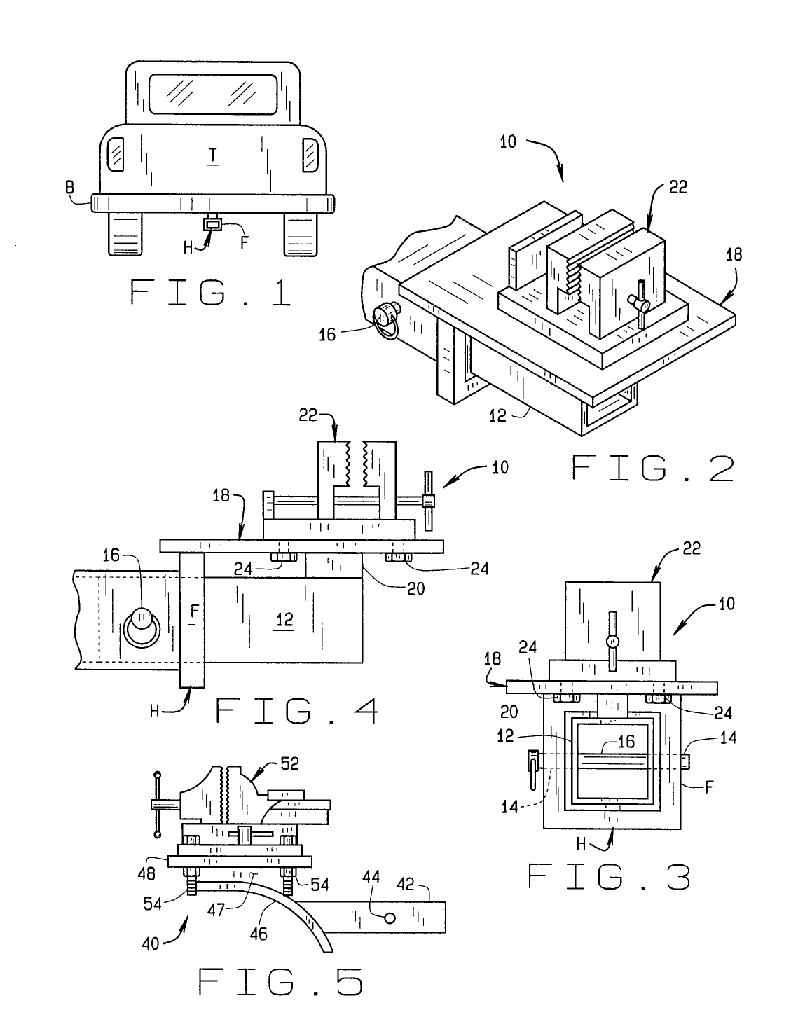

Corresponding reference characters indicate corresponding parts throughout the several views of the drawings.

### DETAILED DESCRIPTION OF THE INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

Referring to the drawings, a truck T has a trailer hitch H affixed to its rear bumper B so to attach a trailer to the truck for towing. The hitch is a conventional hitch. That is, it is hollow, and has a generally square cross-section. A trailer (not shown) to be towed has a hitch member which is inserted into hitch H and attached to the hitch using a pin or bolt or the like.

A vise attachment of the present invention is indicated generally 10 in the drawings. The attachment first comprises a sleeve 12 sized and shaped to fit within hitch H. That is, the sleeve is also generally square in cross-section with the outer dimensions of the sleeve corresponding to the dimensions of the opening formed by the sides of the hitch. The sleeve is made by welding together lengths of a suitable material such as steel or aluminum. The length of sleeve 12 allows it to extend a sufficient distance into the opening in the hitch that the sleeve is stable and does not wobble or slide inside the hitch opening. In addition, the sleeve has opposed openings 14 (see FIG. 3) which register with corresponding, opposed openings in the hitch for a latch pin 16 to be inserted through the openings and secure the sleeve to the hitch. It will be appreciated that openings 14 and pin 16 are exemplary only, and that the sleeve may have a single opening, or a threaded opening, as appropriate, for a threaded bolt or pin to be used to secure the sleeve to the hitch. When installed, the outer end of sleeve 12 of vise attachment 10 extends a substantial distance outwardly from the outer end of the hitch.

A plate 18 is secured to the outer end of sleeve 12. The plate is attached directly to the top of one side of sleeve 12; or, as shown in the drawings, the plate is slightly raised above the sleeve, by an offset 20, so as to rest atop an outer flange F of hitch H. The plate, while shown to be a square plate in the drawings can also be rectangular, round, oval, or other convenient shape, without departing from the scope of the invention. Plate 18 is also a steel or aluminum material, as is offset 20, and the plate (and offset 20) is attached to sleeve 12 by welding, for example. While not overly large, the plate provides an adequate work surface for the user, so they conveniently place tools or other work pieces near the vise for easy access.

Fitted atop plate 18 is a vise 22. The vise is one of a number of conventional vises. The vise is attached to the top of plate 18 by welding; or, as shown in the drawings, is bolted to plate 18 using bolts 24 extending from the underside of the plate. This latter means of attachment allows the vise to be readily removed and replaced with the same or other types of vises, or other tools, used for working with wood, metal or plastic materials.

When not in use, attachment 10 fits in a toolbox or storage compartment in the back of a pickup or a truck. Or, it is sized to fit underneath a seat in the cab of the truck or behind the seat. The attachment is attached to the hitch by sliding the sleeve into the hitch and attaching the sleeve to the hitch with pin 16. Thereafter, the user can perform whatever operations need to be done using the vise (or other tools) as necessary. When done, the user removes pin 16, slides sleeve 12 out of the hitch, and stores the attachment in the truck.

Referring to FIG. 5, an alternate vise attachment construction is indicated generally 40. Attachment 40 comprises a sleeve 42 sized and shaped to fit within hitch H, and the length of the sleeve allows it to slide a sufficient distance within the hitch so that it does not wobble or slide within the hitch. Sleeve 42 has opposed openings 44, only one of which is shown in FIG. 5, that register with corresponding openings in the hitch for the latch pin 16, when inserted through the openings, to secure the sleeve to the hitch. As before, sleeve 42 is made by welding together lengths of a suitable material such as steel or aluminum.

A curved bracket 46 is attached to the outer end of sleeve 42, and a plate 48 is secured to an extension 47 that is connected to an outer, upper end of the bracket. Plate 48, like plate 18, can be a square plate, or a rectangular, round, or oval plate; and can provide a small, but adequate, work surface for the user to conveniently place tools or other work pieces near a vise 52 fitted atop plate 48 for easy access to the vise. In this embodiment, vise 52 is bolted to the top of plate 48 using bolts 54. Again this allows vise 52 to be readily removed and replaced with the same or other types of vises, or other tools, for working with wood, metal, or plastic.

As with vise attachment 10, attachment 40 fits in a toolbox or storage compartment in the back of a pickup or a truck, or underneath or behind a seat in the cab of the truck. As with attachment 10, attachment 40 is attached to hitch H by sliding sleeve 42 into the hitch and attaching the sleeve to the hitch with pin 16. When work requiring use of the vise attachment is done, the user removes pin 16, withdraws sleeve 42 from the hitch, and stores the attachment in the truck.

In view of the above, it will be seen that the several objects and advantages of the present disclosure have been achieved and other advantageous results have been obtained.

Having thus described the invention, what is claimed and desired to be secured by Letters Patent is:

1. An attachment for use with a trailer hitch on a truck or the like to enable a workman to conveniently operate on a piece of wood, metal, or plastic, comprising:
a sleeve inserted in an opening in the hitch;
means securing the sleeve to the hitch;
a plate affixed to an outer end of the sleeve; and,
a tool attached to the plate and for securing the piece of wood, metal, or plastic in place, or for working on the piece.

2. The attachment of claim 1 wherein the plate is round, oval, square, or rectangular, and provides a work surface to assist the workman using the attachment to work on the piece.

3. The attachment of claim 1 in which the tool is a vise.

4. The attachment of claim 1 in which the hitch has an outer end flange and the attachment has an offset on the outer end thereof so the plate is slightly raised above the sleeve and rests atop the flange.

5. The attachment of claim 1 further including a curved bracket attached to the outer end of sleeve, an extension connected to an outer, upper end of the bracket, and the plate being secured to upper end of the extension.
